(19) United States
(12) Patent Application Publication
(10) Pub. No.: US 2002/0101574 A1
(43) Pub. Date: Aug. 1, 2002

(54) Irradiance photometer and exposure apparatus

(75) Inventor: Toshihiko Tsuji, Urawa-shi (JP)

Correspondence Address: OLIFF & BERRIDGE, PLC, P.O. Box 19928, Alexandria, VA, 22320, US

(73) Assignee: NIKON CORPORATION

(21) Appl. No.: 10/104,038

(22) Filed: Mar. 25, 2002

Related U.S. Application Data
(63) Continuation of application No. 09/626,143, filed on Jul. 26, 2000, now abandoned.
Application No. 09/626,143 is a continuation of application No. PCT/JP99/00382, filed on Jan. 29, 1999.

(30) Foreign Application Priority Data
Jan. 29, 1998 (JP) 10-017541

(51) Int. Cl. G03B 27/72

(52) U.S. Cl. 355/69; 355/71; 250/492.2; 250/492.22; 356/399; 356/400

(57) ABSTRACT

In an irradiance photometer comprising a chassis having a light receiving opening formed thereon, and a light detector having a light receiving surface 3a installed in the chassis corresponding to the light receiving opening, a cylindrical portion (shading portion) for intercepting oblique incident radiation to the light receiving opening is provided on the chassis.

This is a Continuation of; International Appln. No. PCT/JP99/00382 filed Jan. 29, 1999 which designated the U.S.

### TECHNICAL FIELD

The present invention relates to an irradiance photometer for measuring the light intensity of illumination light, and an exposure apparatus provided with this irradiance photometer. More particularly, the present invention relates to an irradiance photometer wherein an influence of oblique incident radiation other than illumination light being the object to be measured and an influence of irradiation heat due to the illumination light can be decreased.

### BACKGROUND ART

An irradiance photometer is installed on an optical axis of illumination light, being the object to be measured, and used for light intensity measurement of the illumination light.

FIG. 10 is a sectional view showing a conventional irradiance photometer.

In FIG. 10, the irradiance photometer 1 generally comprises a chassis 2 and a light detector 3. The chassis 2 is a housing having a light receiving opening 2a formed on an upper surface thereof, and is installed on a basement (attachment or holder) 4. The light detector 3 having a light receiving surface 3a installed in the chassis 2 corresponding to the light receiving opening 2a, is mounted on an electrical substrate 5 via a foot 3b. Here, the electrical substrate 5 is connected to the outside of the chassis 2 via wiring 6. Moreover, the light detector 3 receives illumination light P incident from the light receiving opening 2a, and transmits a signal depending on the light intensity, to the outside via the electrical substrate 5 and wiring 6.

As a device having such an irradiance photometer, there can be mentioned for example, a reduction projection type exposure apparatus of a step and repeat method (a so-called stepper) or the like. This stepper is for use in a lithography process for manufacturing semiconductor devices, liquid crystal displays or the like, wherein a pattern image of a reticle serving as a mask is transferred onto and exposed on each shot area on a substrate (wafer, glass plate or the like) on which a photoresist is applied, via a projection optical system.

With this kind of projection exposure apparatus, it is necessary to control the light intensity of exposure light for performing adequate transfer exposure. Hence, prior to the transfer exposure, the light intensity of the exposure light is suitably measured. The irradiance photometer is installed on a stage on which a substrate is mounted, so that by moving the stage in the plane direction, the irradiance photometer is arranged at a predetermined point within an irradiation region of the exposure light.

As shown in FIG. 10, the irradiance photometer 1 is installed, with the light receiving opening 2a being adjusted to the irradiation position of the illumination light P, when the light intensity of the illumination light P being measured. With the irradiance photometer 1 however, incidence of the beam onto the light receiving surface 3a is restricted only by the light receiving opening 2a. Hence, as shown in FIG. 10, in addition to the illumination light P being the object to be measured, oblique incident radiation Q from an optical system having an optical axis inclined with respect to the light receiving opening 2a, for example light from a position detection system that detects a position in the direction of an optical axis of a projection optical system, of a substrate to which a reticle pattern is transferred, is also incident on the light receiving opening 2a as stray light, and the stray light is received by the light receiving surface 3a. As a result, the influence due to the oblique incident radiation Q other than the illumination light P is also added to the output from the light detector 3, causing a problem in that accurate light intensity of only the illumination light P cannot be measured.

Moreover, when the light intensity of the illumination light P is high, the chassis 2 and the light detector 3 are heated due to the irradiation heat, and the output from the light detector 3 drifts due to the heat, causing a problem in that accurate light intensity cannot be measured. In particular, this kind of irradiance photometer 1 may have the outside surface of the chassis 2 painted black in order to prevent the illumination light P from being reflected on the surface of the chassis 2 and hindering accurate light intensity measurement. As a result, the irradiance photometer 1 is likely to be affected by the irradiation heat due to this black paint, and a drift in the output easily occurs.

Problems arising from the conventional irradiance photometer 1 shown in FIG. 10 and used in a projection exposure apparatus such as a stepper or the like described above are as follows.

First of all, in the projection exposure apparatus, the irradiance photometer is installed for measuring the light intensity of the exposure light irradiated onto the shot area. However, onto this shot area, there are irradiated beams of light other than the exposure light, for auto focusing and leveling of the substrate. Therefore, when the light intensity of the exposure light is being measured by the irradiance photometer, beams of light for the auto focusing and leveling are incident on the light detector as stray light, causing a problem in that accurate light intensity of only the exposure light cannot be measured. In particular, for the transfer exposure of fine patterns, accurate light intensity of the exposure light is measured, and an exposure dose for a shot area is controlled to a suitable value depending on the sensitivity of a photoresist, to thereby control the line breadth of the pattern transferred onto the shot area. Therefore, with recent projection exposure apparatus, accurate light intensity measurement of the exposure light is desired.

Secondly, with recent projection exposure apparatus, there is a trend to increase year by year, the illuminance onto a photosensitive substrate in order to improve throughput. Therefore, when the light intensity of the exposure light is measured, the irradiance photometer is subjected to strong irradiation heat, and the output from the light detector drifts due to the heat, causing a measurement error. In particular, when i-lines, g-lines or the like from a mercury lamp are used as the exposure light, the above described problem of the irradiation heat becomes noticeable. Moreover, with an increase in the illumination of the exposure light, heat generation from the light detector and the electrical substrate increases, which causes expansion of the stage on which the substrate is mounted, and fluctuation of the air to the interferometer, causing a baseline drift.

In view of the above described problems, it is an object of the present invention to provide an irradiance photometer that can reduce the influence of stray light such as oblique incident radiation, other than the beams of light being the object to be measured, and the influence of irradiation heat, and to provide an exposure apparatus provided with the irradiance photometer.

### DISCLOSURE OF THE INVENTION

The invention according to claim 1 is an irradiance photometer comprising a chassis having a light receiving opening formed thereon, and a light detector having a light receiving surface installed in the chassis corresponding to the light receiving opening, wherein a technique is adopted in which a shading portion for intercepting oblique incident radiation to the light receiving opening is provided on the chassis. Since the oblique incident radiation to the light receiving opening is intercepted by the shading portion, the irradiance photometer can measure accurate light intensity of the illumination light, by intercepting stray light other than the illumination light being the object to be measured.

The invention according to claim 2 is an irradiance photometer comprising a chassis having a light receiving opening formed thereon, and a light detector having a light receiving surface installed in the chassis corresponding to the light receiving opening, wherein a technique is adopted in which a cover is provided on the chassis which forms a void between the cover and a surface on the light receiving opening side, and has an opening corresponding to the light receiving opening. Since a void is formed between the cover and the surface on the light receiving opening side by the cover, the irradiance photometer can reduce the influence of irradiation heat on the light receiving surface by means of an insulation effect due to the void.

The invention according to claim 3 is an irradiance photometer comprising a chassis having a light receiving opening formed thereon, and a light detector having a light receiving surface installed in the chassis corresponding to the light receiving opening, wherein a technique is adopted in which a cooling device for cooling an inside of the chassis is provided. Since the inside of the chassis is cooled by the cooling device, the irradiance photometer can reduce the influence of irradiation heat on the light receiving surface, and when a light detector and an electrical substrate are installed in the chassis, the irradiance photometer suppresses the heat generated from these from being transferred to other parts.

The invention according to claim 4 is an irradiance photometer according to claim 3, wherein a technique is adopted in which a suction apparatus for drawing out air from inside the chassis is provided as the cooling device. By this suction apparatus, outside air is introduced into the chassis, to thereby cool the inside of the chassis efficiently.

The invention according to claim 5 is an exposure apparatus for transferring a pattern of a mask onto a substrate by means of exposure light, wherein a technique is adopted comprising: a chassis provided on a stage for holding the substrate and having a light receiving opening formed thereon for letting exposure light enter into the chassis; a light detector having a light receiving surface installed in the chassis corresponding to the light receiving opening; and a shading portion provided on the chassis for intercepting oblique incident radiation to the light receiving opening. Since the oblique incident radiation to the light receiving opening is intercepted by the shading portion, the exposure apparatus can intercept light for auto focusing and leveling (oblique incident radiation) other than the exposure light being the object to be measured, enabling measurement of accurate light intensity of the exposure light.

The invention according to claim 6 is an exposure apparatus for transferring a pattern of a mask onto a substrate by means of exposure light, wherein a technique is adopted comprising: a chassis provided on a stage for holding the substrate and having a light receiving opening formed thereon for letting exposure light enter into the chassis; a light detector having a light receiving surface installed in the chassis corresponding to the light receiving opening; and a cover provided on the chassis and forming a void between the cover and a surface on the light receiving opening side, and having an opening corresponding to the light receiving opening. Since a void is formed between the cover and the surface on the light receiving opening side by the cover, the exposure apparatus reduces the influence of irradiation heat such as exposure light or the like on the light receiving surface, by an insulation effect due to this void.

The invention according to claim 7 is an exposure apparatus for transferring a pattern of a mask onto a substrate by means of exposure light, wherein a technique is adopted comprising: a chassis provided on a stage for holding the substrate and having a light receiving opening formed thereon for letting exposure light enter into the chassis; a light detector having a light receiving surface installed in the chassis corresponding to the light receiving opening; and a cooling device for cooling an inside of the chassis. Since the inside of the chassis is cooled by the cooling device, the exposure apparatus reduces the influence of irradiation heat on the light receiving surface, and when a light detector and an electrical substrate are installed in the chassis, the heat generated from these is suppressed from being transferred to the stage on which a substrate is mounted.

The invention according to claim 8 is an exposure apparatus for transferring a pattern of a mask onto a substrate by means of exposure light, wherein a technique is adopted, comprising: a photodetector for photoelectrically detecting the exposure light and having a light receiving surface provided on a stage for holding the substrate; and a blocking device for substantially blocking illumination light other than the exposure light, projected inside an irradiation region of the exposure light, from being detected by the photodetector. With this exposure apparatus, since the illumination light other than the exposure light is blocked from being detected by the photodetector, by the blocking device, the detection result is output from the photodetector based on the exposure light, being the object to be detected.

### BRIEF DESCRIPTION OF DRAWINGS

FIG. 1 is a sectional view showing an embodiment of an irradiance photometer according to the present invention.

FIG. 2 is a sectional view showing another embodiment of an irradiance photometer comprising a shading portion.

FIG. 3 is a perspective view showing an embodiment of an irradiance photometer comprising a cover.

FIG. 4 is a sectional view of the irradiance photometer shown in FIG. 3.

FIG. 5 is a perspective view showing heat flow for the irradiance photometer shown in FIG. 3.

FIG. 6 is a graph wherein the output from a light detector in the irradiance photometer of FIG. 3 is recorded against time.

FIG. 7 is a sectional view showing another embodiment of an irradiance photometer comprising a cover.

FIG. 8 is a perspective view showing an embodiment of an irradiance photometer comprising a cooling device.

FIG. 9 is an elevation view showing an exposure apparatus according to the present invention.

FIG. 10 is a sectional view showing a conventional irradiance photometer:

### BEST MODE FOR CARRYING OUT THE INVENTION

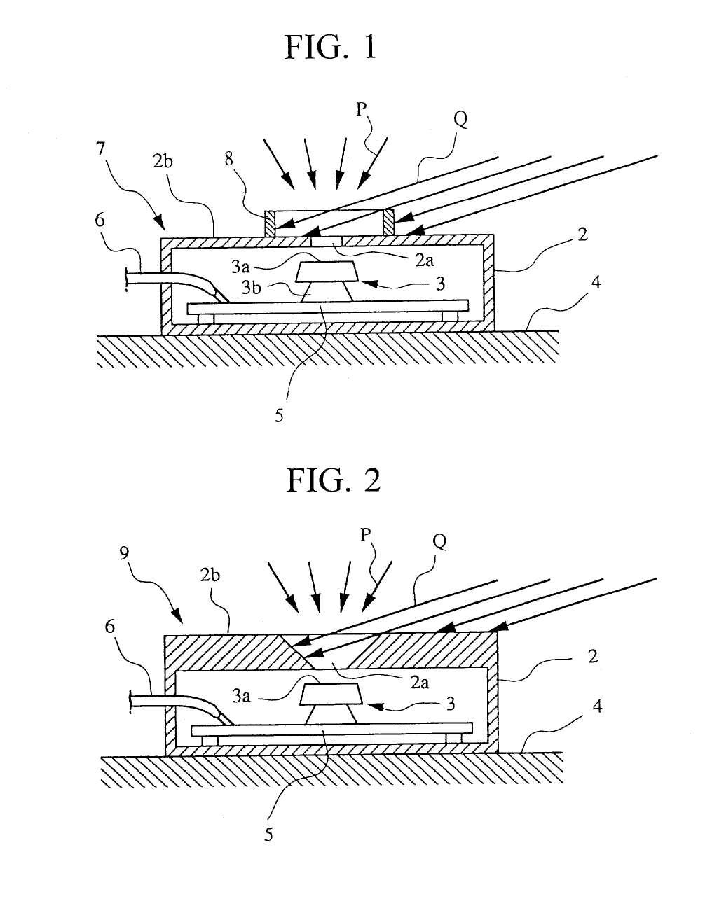

Embodiments of the present invention will now be described with reference to FIG. 1 to FIG. 9. In FIG. 1 to FIG. 9, with regard to members denoted by the same reference symbols as the conventional irradiance photometer 1 shown in FIG. 10, the same members are also used here.

FIG. 1 is a sectional view showing an embodiment of an irradiance photometer according to the present invention.

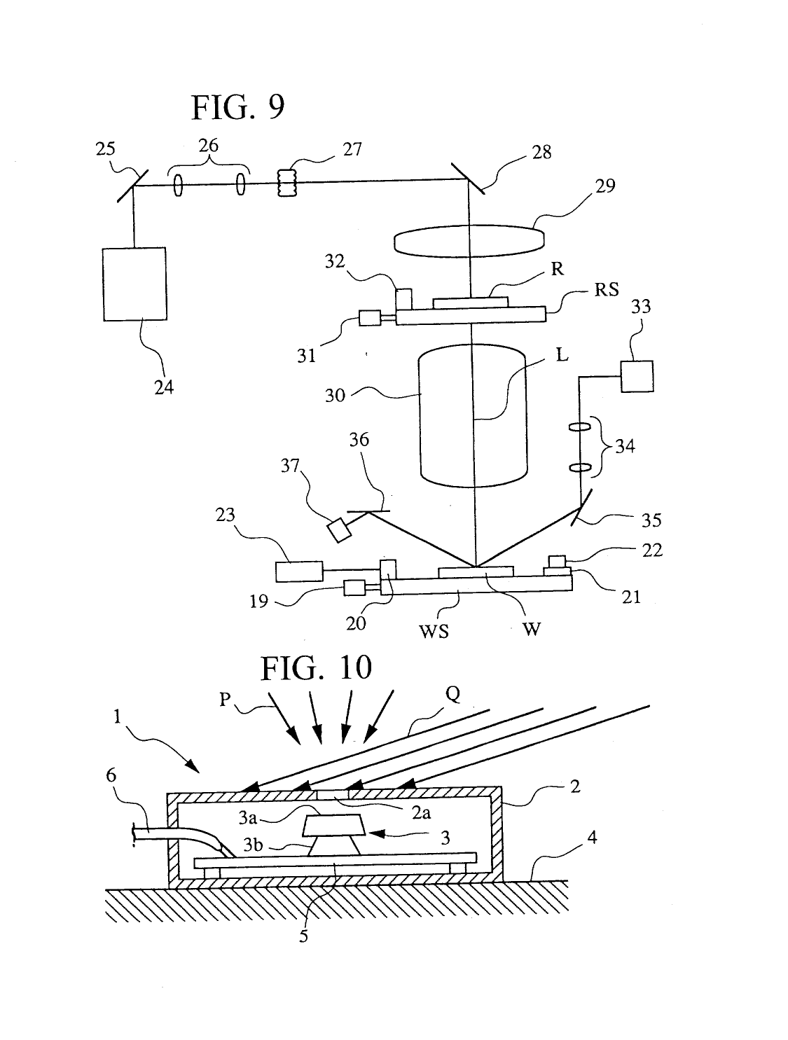

As shown in FIG. 1, an irradiance photometer 7 comprises a chassis 2 and a light detector 3. The chassis 2 is a housing made of a metal having excellent thermal conduction, for example, made of aluminum, having a light receiving opening 2a formed on the upper face thereof, and installed on a basement (attachment or holder) 4. The light detector 3 is, for example, a pin photodiode wherein a light receiving surface 3a is installed inside the chassis 2, corresponding to the light receiving opening 2a, and is mounted on an electrical substrate 5 via a foot 3b. Here, the point that the electrical substrate 5 is connected to the outside of the chassis 2 via wiring 6 is similar to the situation shown in FIG. 9.

Moreover, on the surface of a ceiling portion 2b of the chassis 2 where the light receiving opening 2a is located, a cylindrical portion (shading portion) 8 is provided standing up, surrounding the light receiving opening 2a. The cylindrical portion 8 is produced from aluminum or the like, as with the chassis 2. The height and the inner diameter of the cylindrical portion 8 is determined based on illumination light P being the object to be measured (the numerical aperture, the incident angle or the like), and oblique incident radiation Q being stray light (the sectional shape on the chassis 2, the size, the incident angle or the like). That is to say, as shown in FIG. 1, the height and the inner diameter of the cylindrical portion 8 is determined so that the illumination light P can enter into the light receiving opening 2a but the oblique incident radiation Q is intercepted.

The form of the cylindrical portion 8 shown in FIG. 1 is set for measuring the light intensity of the exposure light in an exposure apparatus described later, and is set based on the diameter of the aperture of the light receiving opening 2a and the numerical aperture (NA) of a projection optical system, so that the exposure light is not rejected by the cylindrical portion 8, but the oblique incident radiation Q does not enter into the light receiving opening 2a. Moreover, the form of the cylindrical portion 8 is not limited to that shown in FIG. 1, and may be for example, a funnel shape with the diameter increasing upwards.

In this manner, since while the light detector 3 is receiving the illumination light P incident from the light receiving opening 2a, the oblique incident radiation Q incident from the light receiving opening 2a is diminished by means of the cylindrical portion 8, a signal corresponding mainly to the light intensity of the illumination light P is transmitted to the outside via the electrical substrate 5 and the wiring 6.

The light detector 3 is not limited to being installed in the chassis 2. That is to say, the light receiving surface 3a needs only be installed in the chassis 2. For example, one end face (light receiving surface) of an optical fiber may be installed in the chassis 2, and light may be transmitted to the light detector 3 outside of the chassis 2 via the optical fiber. In this case, the electrical substrate 5 connected to the light detector 3 is also installed outside of the chassis 2. Needless to say, the exposure light P may be transmitted to the outside of the chassis 2, using the optical element such as a mirror together with the optical fiber, or using the optical element singly.

FIG. 2 is a sectional view showing another embodiment of an irradiance photometer having a shading portion.

As shown in FIG. 2, an irradiance photometer 9 has a chassis 2 with a ceiling portion 2b being made thick, and a light receiving opening 2a is provided with the diameter thereof being enlarged toward the outside of the ceiling portion 2b. In this case, the surface of the thick ceiling portion 2b and the inner face of the light receiving opening 2a serve as the shading portion. The form of the light receiving opening 2a shown in FIG. 2 is set, as with the one shown in FIG. 1, for measuring the light intensity of the exposure light in an exposure apparatus described later, and is set based on the diameter of the aperture at the lower end of the light receiving opening 2a and the NA of a projection optical system, so that the exposure light is not rejected by the surface of the ceiling portion 2b, but the oblique incident radiation Q does not reach the light detector 3. Moreover, the form of the light receiving opening 2a is not limited to that shown in FIG. 2, and may be for example, a form in which the inner diameter does not change.

Furthermore, when the wavelength of the illumination light being the object to be measured (for example, exposure light P) and that of other illumination light (for example, oblique incident radiation Q) is different, the construction may be such that the light receiving opening 2a is formed, for example, by a wavelength selection element (optical bandpass filter) as a shading portion, so that the illumination light being the object to be measured passes therethrough, while the passage of other illumination light is restricted. As a result, stray light other than the light being the object to be measured is restricted from being incident on the light receiving surface 3a. Hence accurate light intensity of the light to be measured can be detected. At this time, the wavelength selection element may be constructed such that it is held by a frame surrounding the light receiving surface 3a, and the light receiving surface 3a and the wavelength selection element may be brought into intimate contact with each other, or the wavelength selection element may be held at a predetermined distance from the light receiving surface 3a. Alternately, the light receiving opening 2a may be formed by depositing a shading material such as chromium or the like onto the wavelength selection element, and subjecting the shading material to blackening.

Here, as described above, a light receiving opening 2a comprising the wavelength selection element may be used singly, or the light receiving openings 2a in the irradiance photometers 7 and 9 shown in FIG. 1 and FIG. 2 may be respectively formed from the wavelength selection element. That is, the cylindrical portion 8 (FIG. 1) or the thick ceiling portion 2b (FIG. 2) may be used together with the wavelength selection element. In this case, even if the cylindrical portion 8 or the thick ceiling portion 2b cannot completely cut off the light not being the object to be measured (such as oblique incident radiation Q) directed toward the photodetecting section 3a, these can obstruct the light not being the object to be measured from impinging on the light receiving surface 3a. Moreover, instead of providing the wavelength selection element separate to the light detector 3, a thin film having a wavelength selection property may be adhered onto the light receiving surface 3a.

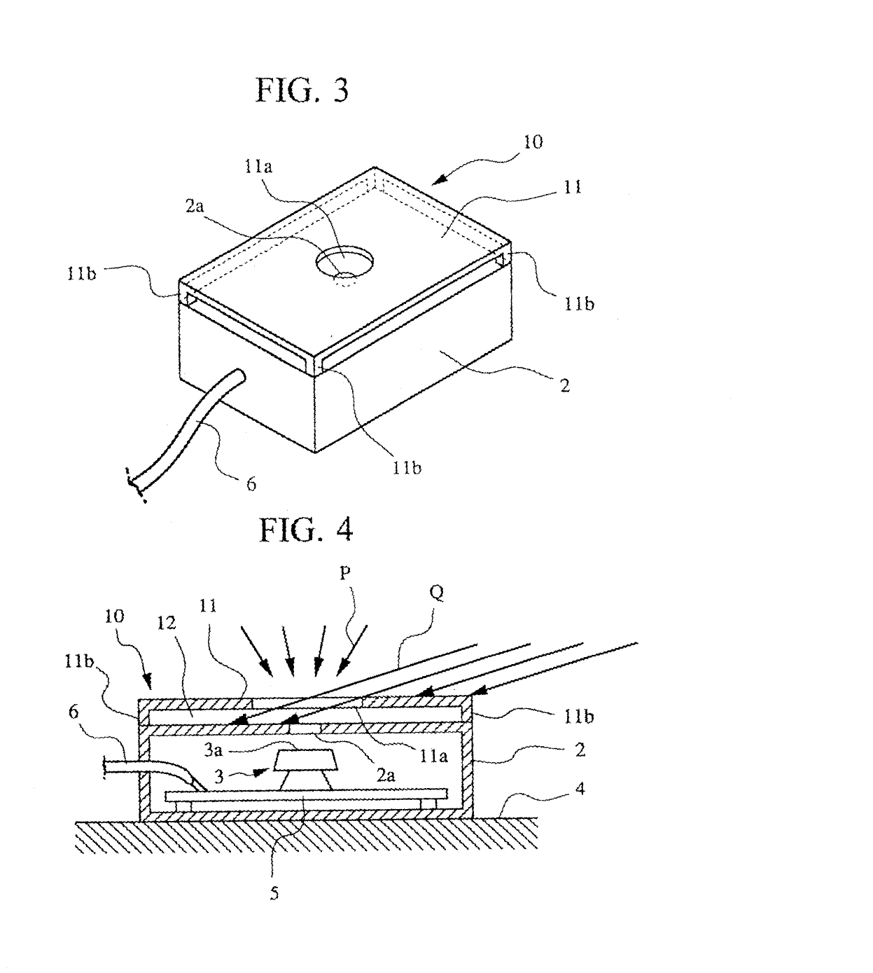

FIG. 3 and FIG. 4 show another embodiment of the irradiance photometer having a shading portion, FIG. 3 being a perspective view and FIG. 4 being a sectional view.

As shown in FIG. 3 and FIG. 4, the irradiance photometer 10 is provided with a cover 11 on a ceiling portion 2b of a chassis 2, via legs 11b. The cover 11 forms a void 12 between the ceiling portion 2b and the cover 11, and comprises an opening 11a corresponding to a light receiving opening 2a. Here, the cover 11 is formed of aluminum or the like having excellent heat transfer, as with the chassis 2.

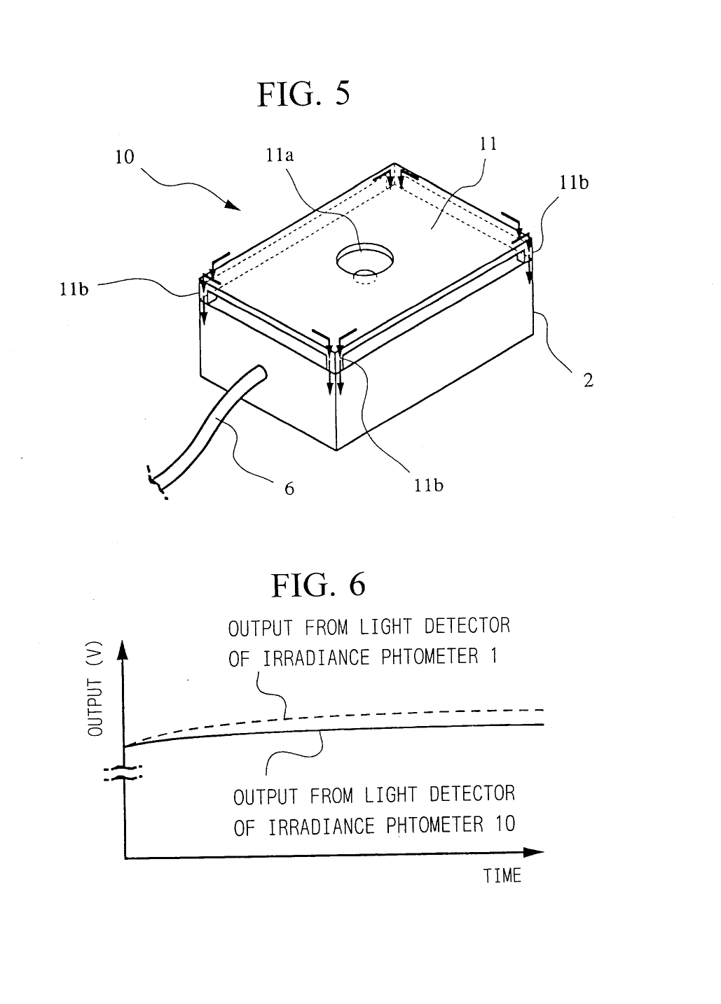

The cover 11 is heated upon receipt of the irradiation heat of the illumination light P and the oblique incident radiation Q. However the heat is unlikely to be transferred to the ceiling portion 2b and a light detector 3 in the chassis 2 due to the void 12. Moreover, the irradiation heat received by the cover 11 is transferred to the side face of the chassis 2 via the legs 11b at four corners, as shown by the arrows in FIG. 5, and then transferred to the basement 4. Therefore, the light detector 3 is unlikely to be affected by the irradiation heat from the illumination light P or the like, and drift in the output is suppressed at the time of measuring the light intensity of the illumination light P, enabling accurate measurement of the light intensity.

Moreover, as shown in FIG. 4, the cover 11 serves as a shading portion by adjusting the diameter of aperture of the light receiving opening 11a and the height of the void 12. That is to say, the form of the cover 11 shown in FIG. 4 is set for measuring the light intensity of the exposure light in the exposure apparatus described later, and is set based on the diameter of the aperture of the light receiving opening 2a and the NA of the projection optical system, so that the exposure light is not rejected by the surface of the cover 11, but the oblique incident radiation Q does not enter from the light receiving opening 2a.

FIG. 6 is a graph wherein the output from respective light detectors 3 in the irradiance photometer 10 in FIG. 3 and the irradiance photometer 1 in FIG. 10, is recorded against time. In the graph of FIG. 6, the solid line shows the output from the light detector 3 of the irradiance photometer 10, and the dotted line shows the output from the light detector 3 of the conventional irradiance photometer 1. From this graph, it is seen that even when the irradiation heat is received, with the irradiance photometer 10, drift in the output of the light detector 3 is suppressed, compared to the case of the conventional irradiance photometer 1.

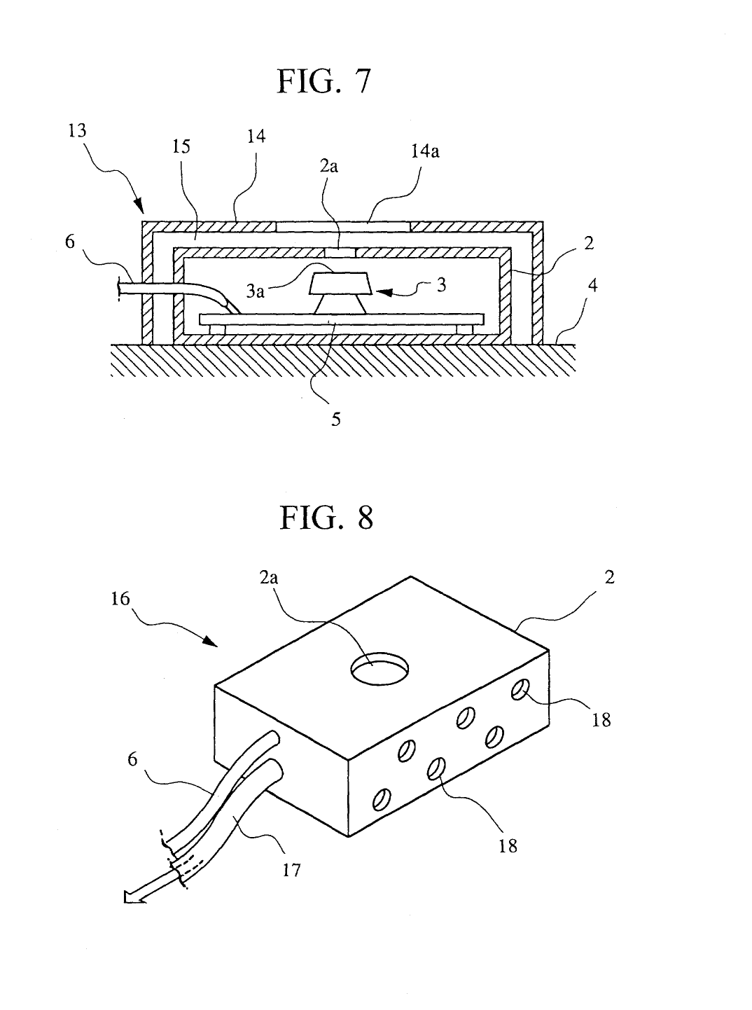

FIG. 7 is a sectional view showing another embodiment of an irradiance photometer provided with a cover, which has the same construction as that of the irradiance photometer 10 shown in FIG. 4, except that a cover 14 is directly provided on a basement 4.

In FIG. 7, an irradiance photometer 13 is provided with the cover 14 so as to cover a chassis 2, and a void 15 is formed between the chassis 2 and the cover 14. Therefore, the irradiation heat received by the cover 14 is directly transferred to the basement 4 via the side face of the cover 14, enabling reduction in heat transfer to the chassis 2. Here, the point that the heat transfer to the chassis 2 is suppressed by the void 15 and that the opening 14a is formed corresponding to the light receiving opening 2a and serves as a shading portion, is similar to that for the embodiment shown in FIG. 3.

Also in the case of the irradiance photometers 10 and 13 shown respectively in FIG. 4 and FIG. 7, the openings 11a, 14a of the respective covers 11, 14 or the light receiving opening 2a may be formed from a wavelength selection element. Moreover, the wavelength selection element may be provided separately from the cover 11 or 14 or the ceiling portion of the chassis 2, in intimate contact with, for example, the light receiving surface 3a, or apart from the light receiving surface 3a by a predetermined distance. Alternatively a thin film having a wavelength selection property may be adhered on the light receiving surface 3a.

FIG. 8 is a perspective view showing an embodiment of an irradiance photometer provided with a cooling device.

In FIG. 8, an irradiance photometer 16 is provided with a cooling device for cooling the inside of the chassis 2. For the cooling device, a suction apparatus (not shown) connected to an end portion of a hose 17 communicated with the inside of the chassis 2 is used, which suppresses heating of the light detector 3 and the electrical substrate 5 by drawing out heated gas from the chassis 2 and introducing outside air into the chassis 2. To efficiently perform introduction of the outside air, a plurality of intakes 18 are formed on the chassis 2. However, the cooling device is not limited to the one shown in FIG. 8, and for example, a pipe for circulating a refrigerant which is set to a predetermined temperature, for example, Florinate (product name), may be arranged in the chassis 2 to thereby cool the inside of the chassis 2 by means of this refrigerant. Alternately, a temperature-controlled gas (air) may be supplied into the chassis 2.

The cooling device shown in FIG. 8 can be applied respectively to the irradiance photometers 7, 9, 10 and 13 shown in FIG. 1, FIG. 2, FIG. 4 and FIG. 7. However, with the irradiance photometer 13 shown in FIG. 7, since the whole chassis 2 is covered with the cover 14, it is desirable to form a plurality of intakes also in the cover 14, to introduce the outside air into the chassis 2. Moreover, the irradiance photometer 10 and 13 shown in FIG. 4 and FIG. 7 may be constructed such that instead of supplying a temperature-controlled gas into the chassis 2, or while supplying the gas into the chassis 2, the temperature-controlled gas is supplied to the void 12, 15 formed between the cover 11, 14 and the chassis 2.

Next is a description of an exposure apparatus according to the present invention.

FIG. 9 is a schema showing an outline of the exposure apparatus. The exposure apparatus is a reduction projection type exposure apparatus of the step and repeat method, a so-called stepper. A wafer stage WS comprises a wafer holder (not shown) for holding a wafer W serving as a substrate, and is constituted by an X stage movable in the X-direction (for example, in the right and left direction in FIG. 9) with respect to a surface plate (not shown) and a Y stage movable in the Y-direction (for example, in the perpendicular direction to the page in FIG. 9). These X stage and Y stage are driven respectively by a drive apparatus 19 (the drive apparatus for the Y stage is not shown). As the drive apparatus, a linear motor or the like may be used.

On the wafer stage WS there is installed a mirror 20, and also installed is an irradiance photometer 22 via a basement 21. Moreover, the position of the wafer stage WS is measured by a laser interferometer 23 installed opposite to a mobile mirror 20. A plurality of places on the wafer stage WS are measured using a plurality of laser interferometers 23. In this way, a position in the X-direction, a position in the Y-direction and a rotation position about the Z-axis (vertical direction in FIG. 9) on the wafer stage WS are measured.

Next, a description is given following along the optical path of the exposure light which exposes the wafer W.

The exposure light from a light source 24 illuminates a reticle R through a mirror 25, a group of lenses 26, an optical integrator (a fly-eye lens in FIG. 9) 27, a mirror 28, and a condenser lens 29, and reaches a wafer W via a projection optical system 30. As the light source 24, there is used a mercury lamp, a KrF excimer laser, an Arf excimer laser, an F₂ laser or the higher harmonics of a YAG laser. When a mercury lamp is used, a filter for taking out i-lines and g-lines used as the exposure light, is installed on the optical path. Here, an aperture stop, a field stop (a reticle blind) and a relay lens system arranged between the optical integrator 27 and the condenser lens 29 are not shown.

The reticle R serving as a mask is held by a reticle stage RS. The reticle stage RS is movable in the X-direction, the Y-direction and the rotation direction about the Z-axis (being the same as above) by means of a drive apparatus 31, and can finely adjust the position of the reticle R. Moreover, a mobile mirror 32 is provided on the reticle stage RS, and the position thereof is measured by a laser interferometer (not shown). The projection optical system 30 has a reduction magnification of, for example ¼ or ⅕, and the optical axis L is respectively orthogonal to the reticle R and the wafer W.

Moreover, the exposure apparatus comprises an auto focus mechanism for relatively moving an image plane of the projection optical system 30 and the wafer W, in order to image a pattern image of the reticle R on one shot area on the wafer W. The auto focus mechanism comprises, as shown in FIG. 9, an AF light source 33, an AF transmission optical system 34, mirrors 35, 36, and a photodetecting sensor 37, and reflects the oblique incident radiation from the AF light source 33 on the wafer W, receives the reflected light by the photodetecting sensor 37, and performs position adjustment of the wafer stage WS in the direction of the Z-axis with respect to the image plane of the projection optical system 30, based on an output from the photodetecting sensor 37.

Though not shown, the auto focus mechanism has a drive mechanism which supports the wafer holder (not shown) on the wafer stage WS by means of three piezoelectric elements (piezo devices or the like), and controls the drive amount of the piezoelectric elements to thereby adjust the position of the wafer holder, that is, the wafer W in the direction of the Z-axis, and the inclination of the projection optical system 30 with respect to the image plane.

Furthermore, the AF sensor (33 to 37) in FIG. 9 is a so-called multipoint AF sensor which projects AF beams respectively onto a plurality measurement points in an image field of the projection optical system 30, that is, the projection area of the reticle pattern, to detect a position of the wafer W at each measurement point, relative to the direction of the Z-axis along the optical axis of the projection optical system 30. Consequently, by detecting the position of the wafer W (shot area) in the direction of the Z-axis, at each of the plurality of measurement points, inclination of the surface in the shot area with respect to the image plane of the projection optical system 30 can be determined. The auto focus mechanism performs an auto leveling operation for driving the wafer holder depending on the determined inclination to thereby set the image plane of the projection optical system 30 approximately parallel to the surface of the shot area, while performing the aforesaid auto focus operation.

In addition, instead of the multipoint AF sensor (33 to 37), an AF sensor which projects AF beams only onto a measurement point (one point) whose position is determined so as to coincide with the optical axis L of the projection optical system 30, and a leveling sensor which projects parallel beams of light onto substantially the whole surface of the shot area on the wafer W to detect average inclination of the surface of the shot area may be combined for use. The parallel beams of light projected from the leveling sensor are also the oblique incident radiation as with the AF beam.

Next is a brief description of an operation of the exposure apparatus. At first, the wafer stage WS moves, based on instructions from a control device (not shown), to thereby match a predetermined shot area on the wafer W with the optical axis L of the projection optical system 30 (a projected image of the reticle pattern). Thereafter, the height and inclination of the wafer W is adjusted by the auto focus and leveling adjustments. Then, the pattern image of the reticle R is reduced and projected onto the shot area on the wafer W by the exposure light via the projection optical system 30, and transferred onto the wafer W. After the transfer, the wafer stage WS is moved to match the projected image of the reticle pattern with the next shot area, and then the next transfer exposure is performed in the same manner as described above. By repeating the step movement of the wafer stage WS and the projection exposure, a plurality of patterns arranged regularly are formed on the wafer W.

In addition to the exposure apparatus of the step and repeat method, a scanning type exposure apparatus of the step and scan method may be used. Recently, the scanning type exposure apparatus of the step and scan method attracts attention, since a wider pattern of the reticle R can be transferred onto the wafer W without increasing the size of the projection optical system 30. This exposure apparatus is for sequentially transferring a pattern image of a reticle R onto each shot area on the wafer W, by scanning a wafer W synchronous with the scanning of the reticle R in a direction perpendicular to the optical axis L of the projection optical system 30, in a direction corresponding thereto (for example, in the opposite direction) and with a speed ratio the same as the magnification of the projection optical system 30.

The scanning type exposure apparatus is disclosed in Japanese Unexamined Patent Application, First Publication No. Hei 4-196513 and corresponding U.S. Pat. No. 5,473,410; and Japanese Unexamined Patent Application, First Publication No. Hei 6-232030 and corresponding U.S. Pat. No. 187,553; (Application date: Jan. 28, 1994) and corresponding Europe Patent No. 0614124 (publication No.), and the disclosure of these publications and U.S. Patents is incorporated herein by reference as a part of this specification, so long as the domestic laws in the designated State or in the elected State designated or elected in this international application permit this.

As shown in FIG. 9, the irradiance photometer 22 is provided on the wafer stage WS via a basement 21. As the irradiance photometer 22, one of those shown in FIG. 1, FIG. 2, FIG. 3, FIG. 7 or FIG. 8 is used, and comprises a chassis 2 installed on the basement 21 and having a light receiving opening 2a formed thereon, and a light detector 3 having a light receiving surface 3a installed in the chassis 2 corresponding to the light receiving opening 2a. The irradiance photometer 22 is moved so that the light receiving opening 2a thereof is positioned at a predetermined point in the image field of the projection optical system 30 (projection area of the reticle pattern), to thereby measure the intensity (illuminance) of the exposure light at the predetermined point. Moreover, irradiance photometers 22 (light receiving opening 2a) are sequentially arranged at a plurality of points in the image field (projection area) to measure the intensity of the exposure light at each point. By so doing, the intensity distribution of the exposure light (illuminance uniformity) and the width of the radiation range of the exposure light can be determined.

At this time, beams of light for auto focusing or for leveling (hereinafter referred to as “beams of light for AF or the like”) other than the exposure light are irradiated onto the wafer stage WS. For example, when the irradiance photometer 7 shown in FIG. 1 is used as the irradiance photometer, even if the intensity of the exposure light at an irradiated position of the AF beam is measured, that is, even if the AF beam coincides with the light receiving opening 2a, since the beams of light for AF or the like other than the exposure light are intercepted by the cylindrical portion (shading portion) 8, accurate light intensity of the exposure light is measured. However, the cylindrical portion 8 is set based on the diameter of aperture of the light receiving opening 2a and the NA of the projection optical system 30, so that the exposure light is not rejected by the cylindrical portion 8, but the beams of light for AF or the like do not enter into the light receiving opening 2a.

Similarly, even when the irradiance photometer 9 shown in FIG. 2 is used as the irradiance photometer, while the exposure light is made to enter into the light receiving opening 2a, the beams of light for AF or the like are prevented from entering into the light receiving opening 2a by means of the surface of the thick ceiling portion 2b. Moreover, since the wavelength of the exposure light, being the object to be measured, and that of the beams of light for AF or the like are different, then for example, the light receiving opening 2a may be formed from a wavelength selection element, as the shading portion, such that the exposure light passes through the wavelength selection element, but the beams of light for AF or the like are restricted from passing through.

Next, when the irradiance photometer 10 shown in FIG. 3 is used as the irradiance photometer, the chassis 2 is covered with the cover 11, and the void 12 is formed between the ceiling portion 2b and the cover 11. In particular, when a mercury lamp is used as the light source 24, the irradiance photometer 22 is subjected to strong irradiation heat from the exposure light (i-lines or the like). As shown in FIG. 4 and FIG. 5 however, due to the insulation effect of the void 12, the irradiation heat is transferred to the side face of the chassis 2 from the legs 11b of the cover 11, and transferred to the wafer stage WS via the basement 21. As a result, heat transfer to the light detector 3 and the electrical substrate 5 is suppressed, and drift in the output of the light detector 3 is avoided.

Moreover, since the diameter of the aperture of the opening 11a of the cover 11 and the height of the void 12 are set based on the diameter of aperture of the light receiving opening 2a and the NA of the projection optical system 30 so that the exposure light is not rejected by the cylindrical portion 8, but the beams of light for AF or the like do not enter into the light receiving opening 2a, the cover 11 functions as a shading portion for intercepting the beams of light for AF or the like.

Similarly, when the irradiance photometer 13 shown in FIG. 7 is used as the irradiance photometer, due to the insulation effect of the void 15, the irradiation heat from the exposure light is transferred to the wafer stage WS from the side face of the cover 14 via the basement 21. As a result the irradiation heat from the exposure light is hardly transferred to the chassis 2, and heat transfer to the light detector 3 and the electrical substrate 5 is further suppressed. Here, the point that the opening 13a functions as a shading portion for the beams of light for AF or the like is the same as the situation with the irradiance photometer 10.

Next, when the irradiance photometer 16 shown in FIG. 8 is used as the irradiance photometer, the air in the chassis 2 is drawn out by a suction apparatus (not shown) via the hose 17, to introduce outside air from intakes 18 or the like. Therefore, the air heated by the irradiation heat from the exposure light is discharged to the outside of the chassis 2 by the suction apparatus, and on the other hand the outside air cools the light detector 3 and the electrical substrate 5. As the cooling device however, the construction may be such that a predetermined refrigerant is circulated in the chassis 2.

Here, though not shown in FIG. 9, the exposure apparatus is provided with a mark detection system (alignment optical system) for detecting a reference mark provided on the wafer stage WS and an alignment mark on the wafer W. As the mark detection system, there can be mentioned a TTL (through the lens) method via the projection optical system 30, and an off axis method having an optical system provided separately from the projection optical system 30. Then, from the detection results for the reference mark by the mark detection system, and the detection results for the reference mark and a mark on the reticle R via the projection optical system 30, a baseline quantity for the mark detection system is determined. When the wafer W is double printed, accurate alignment of each shot area is performed based on the detection results for the alignment mark by the mark detection system and the baseline quantity.

If the heat from the irradiance photometer 22 is transferred to the wafer stage WS, the wafer stage WS is expanded, or fluctuation of air occurs in the vicinity of the mobile mirror 20 thereby causing a position measurement error of the wafer stage WS by the laser interferometer 23. As a result, a baseline drift occurs, and when the wafer W is double printed, each shot area is not accurately aligned.

On the other hand, according to the irradiance photometer 16 shown in FIG. 8 described above, since the inside of the chassis 2 (the light detector 3 and the electrical substrate 5) is cooled by the cooling device, heat transfer to the wafer stage WS is suppressed, thereby suppressing the above described baseline drift, enabling accurate alignment of each shot area.

Here, an insulating material may be provided between the irradiance photometer and the wafer stage WS, so that heat transfer to the wafer stage WS from the irradiance photometer is further suppressed. Moreover, in the case of the irradiance photometers respectively shown in FIG. 1, FIG. 2, FIG. 4, FIG. 7 and FIG. 8, these may be constructed such that, for example, an insulating material is provided on the inner wall of the chassis 2, to reduce heat inwardly transferred from the chassis.

In the above described irradiance photometer, a construction in which the light detector 3 is installed in the chassis 2 is adopted. However instead of this, the construction may be such that one end of an optical fiber is installed in the chassis 2 as a light receiving surface, and the light detector 3 and the electrical substrate 5 are arranged at a position apart from the wafer stage WS. In this case, the optical fiber is set so as to allow the movement of the wafer stage WS. Here, the construction may be such that a plurality of optical elements (lens, mirror and the like) are used instead of the optical fiber, to transmit the exposure light passed through the light receiving opening 2a to the light detector 3 arranged at a fixed part of the apparatus outside of the wafer stage WS, to thereby eliminate a mechanical connection between the wafer stage WS and the light detector 3.

As for the exposure apparatus, according to the one in which the light receiving surface of the photodetector for photoelectrically detecting the exposure light is provided on the wafer stage WS, this comprises a blocking device for substantially blocking the illumination light not being the object to be measured but projected into the irradiation region of the exposure light, from being detected by the photodetector. As this photodetector, other than the irradiance photometer described above, for example, there can be mentioned sensors such as an exposure dose monitor image pickup device (CCD, line sensor). As the blocking device, there can be used a wavelength selection element for restricting passage of the illumination light having a wavelength other than that of the exposure light, separate to the cylindrical portion 8 according to the irradiance photometer 7 of FIG. 1, or the cover 11 according to the irradiance photometer 10 of FIG. 3. Moreover, blocking device also includes the stopping of irradiation of the illumination light (the above described beams of light for AF or the like) other than the exposure light (for example, the stopping of emission of light from the AF light source 33), when the illuminance and exposure dose of the exposure light are being measured.

Furthermore, with the exposure apparatus shown in FIG. 9, the irradiance photometer 22 is fixed on the wafer stage WS. However, to detect the intensity of respective exposure light by a plurality of exposure apparatus and compare the intensity, there is a situation where an operator sequentially installs one irradiance photometer in a plurality of exposure apparatus. Therefore, this irradiance photometer is made detachable with respect to the wafer stage. The present invention can also be applied to such an irradiance photometer, and can obtain similar effects.

The present invention is applicable not only to an irradiance photometer or exposure dose monitor, but also to a detection system wherein a mark on a reticle R is illuminated by exposure light and the mark image formed by a projection optical system 30 is photo-detected by a photoelectric detector through an aperture arranged on a wafer stage, in order to measure, for example, the imaging characteristics (magnification, focal point, aberration or the like) of the projection optical system 30. This detection system is disclosed, for example, in Japanese Unexamined Patent Application, First Publication No. Hei 8-83753 and corresponding U.S. Pat. No. 5,650,840, and the disclosure of this publication and U.S. Patent is incorporated herein by reference as a part of this specification, so long as the domestic laws in the designated State or in the elected State designated or elected in this international application permit this.

Respective irradiance photometers shown in FIG. 1 to FIG. 8 are applicable to various apparatus which require measurement of light intensity of illumination light, such as various kinds of survey instruments and measurement apparatus.

Moreover, the exposure apparatus shown in FIG. 9 is for manufacturing semiconductor devices. However the exposure apparatus is not limited thereto, and may be for manufacturing liquid crystal displays, image pickup devices (CCD) and thin-film magnetic heads. In the case of the exposure apparatus for manufacturing liquid crystal displays, the wafer stage WS is a plate stage, and a glass plate is held thereon. In the case of the exposure apparatus for manufacturing thin-film magnetic heads, a ceramic wafer is used instead of the semiconductor wafer.

There is a situation where reticles or masks used in an exposure apparatus for manufacturing semiconductor devices or the like, are manufactured by an exposure apparatus using, for example, far ultraviolet rays or vacuum-ultraviolet light. The present invention is applicable also to such exposure apparatus used in a photolithography process for manufacturing reticles or masks.

The present invention is also applicable to a reduction projection type exposure apparatus which uses, for the exposure illumination light, a laser plasma light source, or a soft-X-ray region (wavelength of about 5 to 15 nm) generated from a SOR, for example, EUV (Extreme Ultra Violet) rays having a wavelength of 13.4 nm or 11.5 nm, or an exposure apparatus of a proximity method which uses hard X-rays. With the EUV exposure apparatus, the reduction projection optical system is a catoptric system comprising only a plurality of (about 3 to 6) reflection optical elements, and a reflection type system is used for a reticle. With a photodetector (irradiance photometer or the like) for detecting EUV rays or hard X-rays, for example a substance which generates fluorescence upon irradiation of the EUV rays or hard X-rays is formed on the light receiving surface, and the fluorescence is received to detect the intensity.

Moreover with the exposure apparatus of FIG. 9, for the exposure illumination light, there may be used harmonics in which a single wave laser in an infrared region or in a visible range oscillated from a DFB semiconductor laser or a fiber laser is amplified by a fiber amplifier doped with, for example, erbium (or erbium and yttribium), and the waveform thereof is converted into ultraviolet rays using a non-linear optical crystal.

Furthermore, the projection optical system 30 mounted on the exposure apparatus of FIG. 9 may be any of a dioptric system, catoptric system, and cata-dioptric system. As the cata-dioptric system, for example, as disclosed in U.S. Pat. No. 5,788,229, there can be used an optical system wherein a plurality of dioptric elements and two catoptric elements (at least one being a concave mirror) are arranged on the optical axis extending in a straight line without being bent. The disclosure of this U.S. Patent is incorporated herein by reference as a part of this specification, so long as the domestic laws in the designated State or in the elected State designated or elected in this international application permit this. In addition, the present invention is applicable not only to an exposure apparatus having a projection optical system, but also to an exposure apparatus of a proximity method.

Here, at least a part of a projection optical system with a plurality of optical elements incorporated in a body tube, and an illumination optical system comprising a multiplicity of optical elements (including an optical integrator), is fixed on a frame, and the frame is supported by a vibration isolator having three or four vibration-isolating pads arranged on a base plate. Moreover, a wafer stage is arranged on a base suspended on the frame, and the base on which a reticle stage is arranged is fixed on a column which is disposed on the frame. Furthermore, the irradiance photometer shown in either of FIG. 1, FIG. 2, FIG. 4, FIG. 7 or FIG. 8 is fixed on the wafer stage, and wiring and piping are connected to the irradiance photometer. Then, the projection exposure apparatus shown in FIG. 9 can be manufactured by respectively performing optical adjustment of the illumination optical system and the projection optical system, connecting wiring and piping to the reticle stage and the wafer stage comprising a multiplicity of mechanical parts, and performing overall adjustment (electrical adjustment, operation confirmation and the like). The production of the exposure apparatus is preferably performed in a clean room where temperature and cleanliness and the like are controlled.

Moreover, semiconductor devices are produced through a step for designing the function and performance of the device, a step for manufacturing reticles based on the design step, a step for manufacturing a wafer from a silicon material, a step for exposing a pattern of the reticle onto the wafer by the exposure apparatus of FIG. 9, a step for assembling each device (including a dicing step, a bonding step and a packaging step), and an inspection step.

Furthermore, various shapes and combinations shown in the aforesaid respective embodiments are one example only, and can be variously modified based on design requirements without departing from the gist of the present invention.

### INDUSTRIAL FIELD OF APPLICATION

As described above, according to the irradiance photometer of claim 1, since the oblique incident radiation to the light receiving opening is intercepted by the shading portion, accurate light intensity of the illumination light can be measured, by intercepting stray light other than the illumination light being the object to be measured.

According the irradiance photometer of claim 2, since the void is formed between the cover and the surface on the light receiving opening side by the cover, the influence of irradiation heat on the light receiving surface (including the photodetecting element and electrical substrate) can be suppressed by means of the insulation effect due to the void. Hence the drift of the output of the photodetecting element can be suppressed, so that accurate light intensity of the illumination light can be measured.

According to the irradiance photometer of claim 3, since the inside of the chassis is cooled by the cooling device, the influence of irradiation heat on the light receiving surface can be reduced, and when a light detector and an electrical substrate are installed in the chassis, the heat generated from these can be suppressed from being transferred to other parts.

According to the irradiance photometer of claim 4, since a suction apparatus for drawing out air from inside the chassis is provided as the cooling device, heated gas inside the chassis is discharged to the outside by the suction apparatus, and outside air is introduced into the chassis, so that the inside of the chassis can be cooled efficiently.

According to the exposure apparatus of claim 5, since the oblique incident radiation to the light receiving opening is intercepted by the shading portion, light for auto focusing and leveling (oblique incident radiation) other than the exposure light being the object to be measured can be intercepted by the shading portion, enabling measurement of accurate light intensity of the exposure light.

According the exposure apparatus of claim 6, since the void is formed between the cover and the surface on the light receiving opening side by the cover, the influence of irradiation heat from the exposure light and the like on the light receiving surface (including the photodetecting element and electrical substrate) can be suppressed by means of the insulation effect due to the void. Hence the drift of the output of the photodetecting element can be suppressed, so that accurate light intensity of the exposure light can be measured.

According to the exposure apparatus of claim 7, since the inside of the chassis is cooled by the cooling device, the influence of irradiation heat on the light receiving surface can be reduced, and when a light detector and an electrical substrate are installed in the chassis, the heat generated from these can be suppressed from being transferred to the stage on which the substrate is mounted. Moreover, expansion of the stage due to heat from the light detector and the electrical substrate, and fluctuation of air into the interferometer, can be suppressed, so that baseline drift can be avoided.

According to the exposure apparatus of claim 8, since the illumination light other than the exposure light is blocked from being detected by the photodetector, by the blocking device, a detection result can be obtained from the photodetector based on the exposure light being the object to be detected.

1. An exposure apparatus that exposes an object with an exposure beam comprising:
a beam detection apparatus that detects said exposure beam by receiving said exposure beam with a light receiving portion; and
a shading portion provided with a shape which allows a beam incident on a light receiving surface from a direction which is almost the same as the irradiation direction of said exposure beam, and which blocks oblique beams from a direction different from the direction of said exposure beam from reaching the light receiving surface.

2. An exposure apparatus according to claim 1, wherein said beam detection apparatus is provided with a filter that blocks the passage of said oblique beams together with said shading portion.

3. An exposure apparatus according to claim 1, having a suppression device that suppresses the influence of heat due to irradiation of said exposure beam.

4. An exposure apparatus according to claim 3, wherein said suppression device suppresses the influence of said heat due to irradiation of said exposure beam by flowing air which has been subjected to the influence of said heat.

5. An exposure apparatus according to claim 1, further comprising a stage that holds and moves said object, wherein
said light receiving portion of said beam detection apparatus is provided on said stage.

6. An exposure apparatus according to claim 5, having an object position information detection apparatus that detects position information of said object by irradiating said oblique beams onto said object which is held on said stage.

7. An exposure apparatus according to claim 6, having an exposure optical system that guides said exposure beam to said object, wherein said object position information detection apparatus detects said position information of said object related to an optical axis direction of said projection optical system.

8. An exposure apparatus that exposes an object with an exposure beam comprising:
a beam detection apparatus that detects said exposure beam by receiving said exposure beam with a light receiving portion; and
a member that forms a void that suppresses an influence of heat due to irradiation of said exposure beam, on a side of said light receiving portion which is irradiated by said exposure beam.

9. An exposure apparatus according to claim 8, wherein said member that forms said void has a shape which allows a beam incident on a light receiving surface from a direction which is almost the same as the irradiation direction of said exposure beam, and which blocks oblique beams from a direction different from the direction of said exposure beam from reaching the light receiving surface.

10. An exposure apparatus according to claim 8, wherein said beam detection apparatus has a filter that blocks the passage of said oblique beams irradiated from a direction different to that of said exposure beam.

11. An exposure apparatus according to claim 8, having a suppression device that suppresses the influence of said heat due to irradiation of said exposure beam by flowing air which has been subjected to the influence of said heat.

12. An exposure apparatus according to claim 8, further comprising a stage that holds and moves said object, wherein
said light receiving portion of said beam detection apparatus is provided on said stage.

13. An exposure apparatus according to claim 12, having a stage position information detection device that detects position information of said stage.

14. A manufacturing method for an exposure apparatus that manufactures an exposure apparatus according to claim 1, including a step of attaching said beam detection apparatus.

15. A beam detection apparatus that detects an exposure beam by receiving said exposure beam with a light receiving portion, comprising:
a shading portion provided with a shape which allows a beam incident on a light receiving surface from a direction which is almost the same as the irradiation direction of said exposure beam, and which blocks oblique beams from a direction different from the direction of said exposure beam from reaching the light receiving surface.

16. A beam detection apparatus according to claim 15, wherein said shading portion is provided with a filter that blocks the passage of said oblique beams from a direction different from the direction of said exposure beam.

17. A beam detection apparatus according to claim 15, further comprising a suppression device that suppresses the influence of heat due to irradiation of said exposure beam.

18. A beam detection apparatus according to claim 17, wherein said suppression device flows air which has been subjected to influence of said heat, to thereby suppress the influence of said heat.

19. A beam detection apparatus that detects an exposure beam by receiving said exposure beam with a light receiving portion, comprising:
a member that forms a void that suppresses an influence of heat due to irradiation of said exposure beam, on a side of said light receiving portion which is irradiated by said exposure beam.

20. A beam detection apparatus according to claim 19, wherein said member that forms a void is provided with a shape which allows a beam incident on a light receiving surface from a direction which is almost the same as the irradiation direction of said exposure beam, and which blocks oblique beams from a direction different from the direction of said exposure beam from reaching the light receiving surface.

21. A beam detection apparatus according to claim 19, further comprising a filter that blocks the passage of said oblique beams from a direction different from the direction of said exposure beam.

22. A beam detection apparatus according to claim 19, further comprising a suppression device that suppresses the influence of said heat due to irradiation of said exposure beam by flowing air which has been subjected to the influence of said heat.

23. A manufacturing method for an exposure apparatus that manufactures an exposure apparatus according to claim 8, including a step of attaching said beam detection apparatus.
